(19) United States
(12) Patent Application Publication
(10) Pub. No.: US 2019/0101896 A1
(43) Pub. Date: Apr. 4, 2019

(54) CONTROLLED 3-D PRINTING

(71) Applicant: Walmart Apollo, LLC, Bentonville, AR (US)

(72) Inventors: Robert L. Cantrell, Herndon, VA (US); Bruce W. Wilkinson, Rogers, AR (US)

(21) Appl. No.: 16/145,563

(22) Filed: Sep. 28, 2018

Related U.S. Application Data
(60) Provisional application No. 62/565,899, filed on Sep. 29, 2017.

(51) Int. Cl. G05B 19/4099; H04L 9/06; B33Y 50/02

(52) U.S. Cl. CPC G05B 19/4099; H04L 9/0637; H04L 2209/38; G05B 2219/49007; B33Y 50/02

(57) ABSTRACT

A control circuit accesses 3-D printing instructions provided by a user and assesses those instructions to determine inclusion of printing authorization from a presumptive source of the 3-D printing instructions. Upon determining that the printing instructions lack such a printing authorization, the control circuit halts further use of the printing instructions. Upon determining that the printing instructions do include that printing authorization, however, the control circuit then further assesses the printing instructions to thereby further test legal suitability of using the printing instructions with the additive-material printer to form that three-dimensional object. Upon establishing the further legal suitability of using the printing instructions, the control circuit then uses the additive-material printer to form the particular three-dimensional object.

### CROSS-REFERENCE TO RELATED APPLICATION

This application claims the benefit of U.S. Provisional Application No. 62/565,899, filed Sep. 29, 2017, and is incorporated herein by reference in its entirety.

### TECHNICAL FIELD

These teachings relate generally to additive-material printers including three-dimensional (3-D) printers.

### BACKGROUND

Additive-material printing, sometimes loosely referred to as 3-D printing, comprises a known and active area of endeavor. Additive-material printing refers generally to any of a variety of processes that manufacture (i.e., “print”) three-dimensional objects by adding in a successive manner constituent raw material. So-called 3-D printers typically add that content through a plurality of successively-applied layers. In these regards, additive-material printing stands in stark contrast to other manufacturing techniques such as casting or molding, fabrication, stamping, and machining.

Additive-material printing can accommodate a wide variety of raw materials including metals and plastics. Additive-material printers typically employ printing instructions that govern movement, placement, and operating state of the printer's print heads and various other operating parameters of the printer (such as temperatures) that specify the three-dimensional addition of the material of choice to thereby form the desired three-dimensional object.

Additive manufacturing is generally viewed as holding great promise, especially for many semi-custom or otherwise specialized purposes. For example, additive manufacturing offers a potentially effective and efficient way to build rare items (such as spare parts for obsolete apparatuses) and otherwise relatively unique items.

That said, the promise of additive manufacturing continues to elude many due to a variety of factors. For example, the requirements of a particular printing task (regarding, for example, one or more of print resolution, printed material, size of the printed object, printing speed, and so forth) may limit the task to only certain printers (because not all printers are able to accommodate all potential print job requirements).

In some cases, some companies or institutions are considering making their 3-D printers available for use by members of the public. Such availability, at present, remains more mere possibility than reality, however. One significant concern that prevents some entities from offering their facilities in this way is the risk of legal liability. In particular, 3-D printers, unfortunately, offer a simple and powerful way to make unauthorized copies of legally-protected objects. Technical solutions to address such concerns are, at present, both rare and of limited scope and value. In particular, the employed technologies may be insufficiently comprehensive, may be too slow, and/or may require an undue amount of human oversight.

### BRIEF DESCRIPTION OF THE DRAWINGS

The above needs are at least partially met through provision of the controlled 3-D apparatus and process described in the following detailed description, particularly when studied in conjunction with the drawings, wherein:

FIG. 1 comprises a block diagram as configured in accordance with various embodiments of these teachings;

FIG. 2 comprises a block diagram as configured in accordance with various embodiments of these teachings;

FIG. 3 comprises a flow diagram as configured in accordance with various embodiments of these teachings;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings; and

FIG. 9 comprise a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments an apparatus facilitates controlling use of printing instructions for a particular three-dimensional object by an additive-material printer. A control circuit accesses printing instructions provided by a user and assesses those instructions to determine inclusion of printing authorization from a presumptive source of the printing instructions. Upon determining that the printing instructions lack such a printing authorization, the control circuit halts further use of the printing instructions. Upon determining that the printing instructions do include that printing authorization, however, the control circuit then further assesses the printing instructions to thereby further test legal suitability of using the printing instructions with the additive-material printer to form that three-dimensional object. Upon establishing the further legal suitability of using the printing instructions, the control circuit then uses the additive-material printer to form the particular three-dimensional object.

By one approach the control circuit tests the aforementioned legal suitability by, at least in part, comparing information regarding the object to stored information regarding a plurality of protected objects. The latter information may be accessed via a remote resource and/or a remote resource may itself conduct the aforementioned comparison.

By one approach, upon determining that it is not legally suitable to use the printing instructions to form the particular three-dimensional object, the control circuit can halt further use of the printing instructions. In combination with the foregoing or in lieu thereof, the control circuit can also automatically provide corresponding information to a legally-relevant entity (such as, for example, the entity that is a presumptive source of the particular three-dimensional object).

These teachings are flexible in practice and will accommodate various modifications and/or supplemental features. By one example, the control circuit accesses the printing instructions by accessing the printing instructions as appear in a blockchain block. In such a case, if desired, the aforementioned printing authorization can include a blockchain public key that corresponds to the aforementioned presumptive source.

So configured, these teachings can greatly facilitate both widespread and relatively unencumbered use of additive-material printers while simultaneously offering significant protection against the infringement of object-based rights of various third parties. These teachings do not rely unduly upon representations made by the user nor do these teachings necessarily require a significant amount of time to accomplish. These teachings are also capable of being implemented with little or no human oversight in ordinary course of usage.

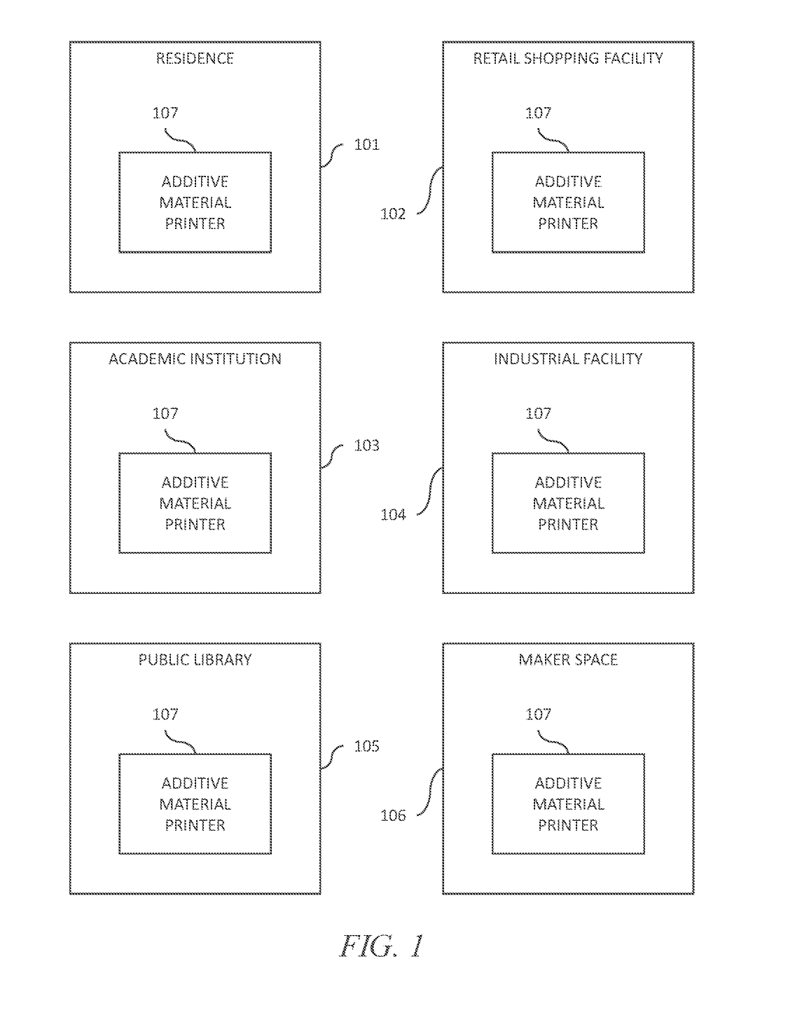

These and other benefits may become clearer upon making a thorough review and study of the following detailed description. Referring now to the drawings, and in particular, to FIG. 1, these teachings can be successfully applied in any of a variety of application settings. As a few illustrative examples in these regards, these teachings can be applied with respect to one or more additive-material printers 107 that are located in any of a residential setting 101, a retail shopping facility 102, an academic institution 103, any commercial or industrial facility 104, any public facility such as a public library 105, or a so-called maker space 106. It will be understood that these examples are intended to serve an illustrative purpose and are not intended to represent an exhaustive listing in these regards.

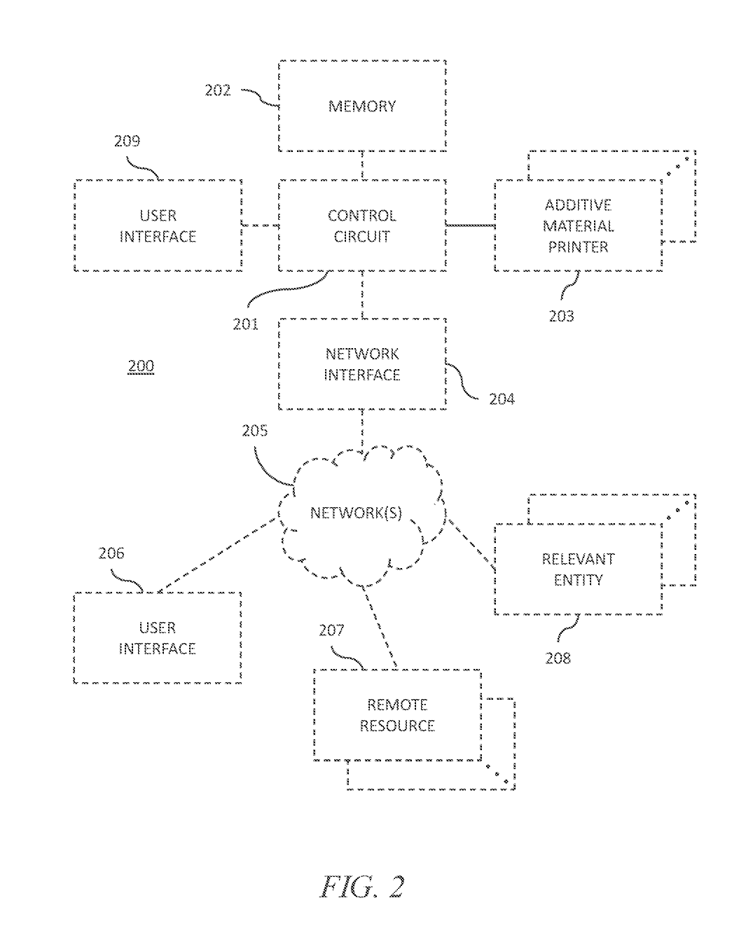

FIG. 2 presents a more detailed example of an illustrative apparatus 200 that comports with these teachings. This apparatus 200 serves to facilitate controlling the use of printing instructions for a particular three-dimensional object by an additive-material printer as described herein.

In this particular example, the enabling apparatus 200 includes a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to some or all of the information mentioned herein, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this illustrative example the control circuit 201 operably couples to an additive-material printer 203 (or printers) such as but not limited to any of a variety of 3-D printers as are known in the art. By one approach the control circuit 201 fully controls the functionality of the additive-material printer 203. These teachings will also accommodate, however, the control circuit 201 only partially controlling the additive-material printer 203 such that the latter has at least some autonomous capability. These teachings are not overly sensitive to the selection of any particular additive-material printer and accordingly further elaboration with respect to such printers is not presented here.

If desired the control circuit 201 can also operably couple to a network interface 204. Numerous examples of network interfaces are known in the art. A non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi™-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces.

So configured the control circuit 201 can communicate with other elements (both within the apparatus 200 and external thereto, such as a user interface 206, one or more remote resources 207, and/or one or more relevant entities 208 as described herein) via one or more intervening data/communications networks 205 such as but not limited to the Internet.

By another optional approach (in lieu of the foregoing or in combination therewith) the control circuit 201 operably couples to a local user interface 209 (as versus the above-mentioned remote user interface 106). These user interfaces 206 and 209 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

Such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform.

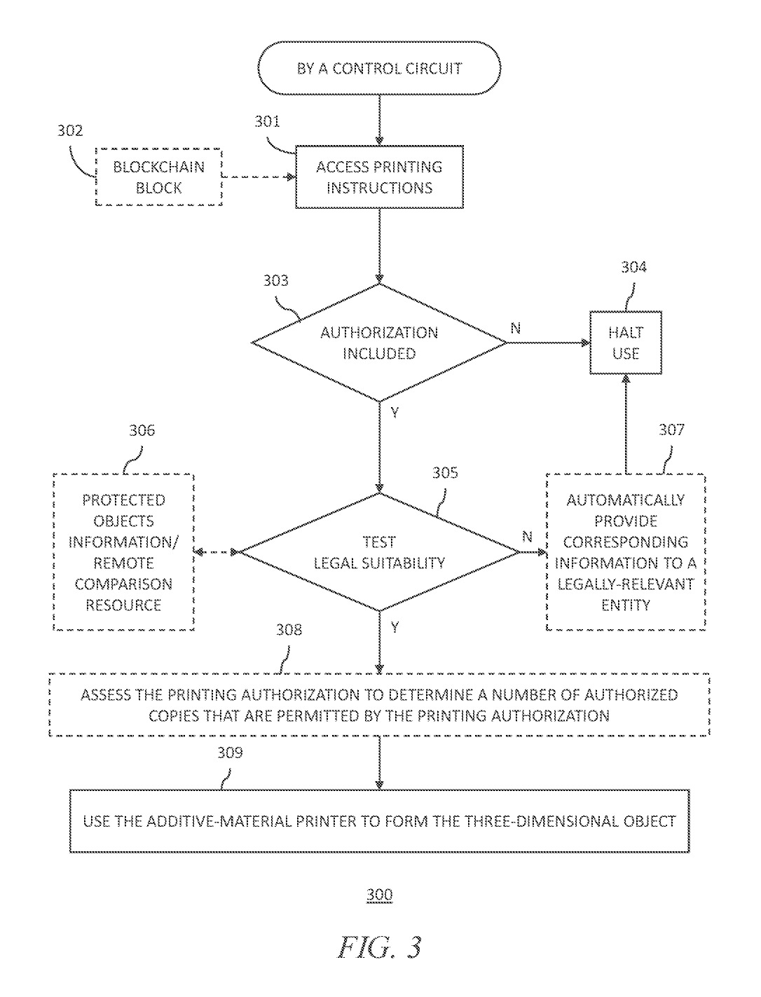

FIG. 3 presents a process 300 that can be carried out by the above-described apparatus 200 via, in particular, the aforementioned control circuit 201. At block 301 the control circuit 201 accesses printing instructions that are provided by a user. By one approach these printing instructions are input via one of the aforementioned user interfaces 206 and 209. These teachings are highly flexible in these regards, however, and will readily accommodate other approaches in these regards. (By one optional approach, and as illustrated at block 302, the printing instructions can be provided, in whole or in part, as one or more blockchain blocks. Further discussion is provided below in these regards.)

At block 303 the control circuit 201 assesses the printing instructions to determine whether the printing instructions include printing authorization from a presumptive source of the printing instructions (i.e., from a person or entity who originated the accessed printing instructions). This authorization can assume any of a variety of forms and content. By one approach the authorization includes a specific text string that includes the requisite printing authorization. If desired, the printing authorization can include additional information including but not limited to identifying information for the sourcing entity, payment information, contact information, and so forth.

In the absence of the requisite printing authorization, at block 304 the control circuit 201 halts any further use of the printing instructions (at least in terms of any subsequent additive-material printing for the corresponding particular three-dimensional object). If desired, this haltage can include logging activities to maintain an auditable record of these events and/or sourcing a message back to the user to provide such information as may be desired regarding the haltage.

Upon determining that the printing instructions do include the requisite printing authorization, at block 305 this process 300 provides for further assessing the printing instructions to thereby further test legal suitability of using the printing instructions with the additive-material printer 203 to form the particular three-dimensional object. Accordingly, it will be understood that this process 300 provides for more than merely confirming the originating party's own authorization and possible self-serving (and/or false) authorization representations. It will, therefore, be further understood that this additional test regarding legal suitability does not include any vetting of the entity that presented the printing instructions and does not include, for example, confirmation that the originating entity has made any particular representations regarding their own right to print the particular three-dimensional object.

By one optional approach, and with reference to block 306, testing the legal suitability of using the printing instructions with the additive-material printer to form the particular three-dimensional object includes, at least in part, comparing information regarding the particular three-dimensional object against stored information regarding a plurality of protected objects. That comparison can be conducted at the control circuit 201 or can be conducted, in whole or in part, at a remote resource 207 (such as a suitably configured server).

So configured, and generally speaking, the aforementioned comparison can serve to compare some or all of the salient details (in particular, external visually-ascertainable details) of the particular three-dimensional object against previously registered or otherwise stored images and objects. As one simple illustrative example, a game maker can register or otherwise make available descriptive information and/or examples regarding their (real or virtual) game pieces or figures. That information can then be compared against the printing instructions to determine whether the three-dimensional object that would be created by the printing instructions would be identical to one or more of the game makers game pieces/figures.

These teachings will also accommodate determining whether the resultant printed three-dimensional object would be, although not identical, at least sufficiently similar to warrant a same conclusion. In such a case, the requisite degree of similarity can be defined as desired. As one example, a given printed object may be considered “sufficiently identical” when no single relative measurement is more than five per cent different from the representative example(s).

When a determination concludes that it is not legally suitable to use the printing instructions with the additive-material printer to form the particular three-dimensional object, the control circuit 201 can halt any further use of the printing instructions (as shown at block 304). If desired, the control circuit 201 can also automatically provide corresponding information regarding these circumstances to a legally-relevant entity (as illustrated at optional block 307). An example of a legally-relevant entity is a law enforcement agency and/or the presumptive source (for example, the owner of record) of the particular three-dimensional object itself as evidenced by the aforementioned comparison.

These teachings will accommodate a wide variety of objects including, but not limited to, animated characters and images, figurines and statuary, tools, automobile parts, furniture, medical devices, dinnerware, and so forth.

Upon establishing the aforementioned further legal suitability of using the printing instructions, by one optional approach (and as shown at block 308) the control circuit 201 can assess the printing authorization to determine the number of authorized copies that are permitted by the printing authorization. In any event (and again assuming that the control circuit 201 has established the further legal suitability of using the printing instructions), at block 309 the control circuit 201 uses the aforementioned additive-material printer 203 to form the particular three-dimensional object.

As mentioned above with reference to optional block 302, the printing instructions can be provided by the user in a blockchain block. For example, by one approach the aforementioned printing authorization can include a blockchain public key that corresponds to the presumptive source of the entity to print the particular three-dimensional object or that sourced the original particular three-dimensional object (and therefore may constitute the aforementioned legally-relevant entity).

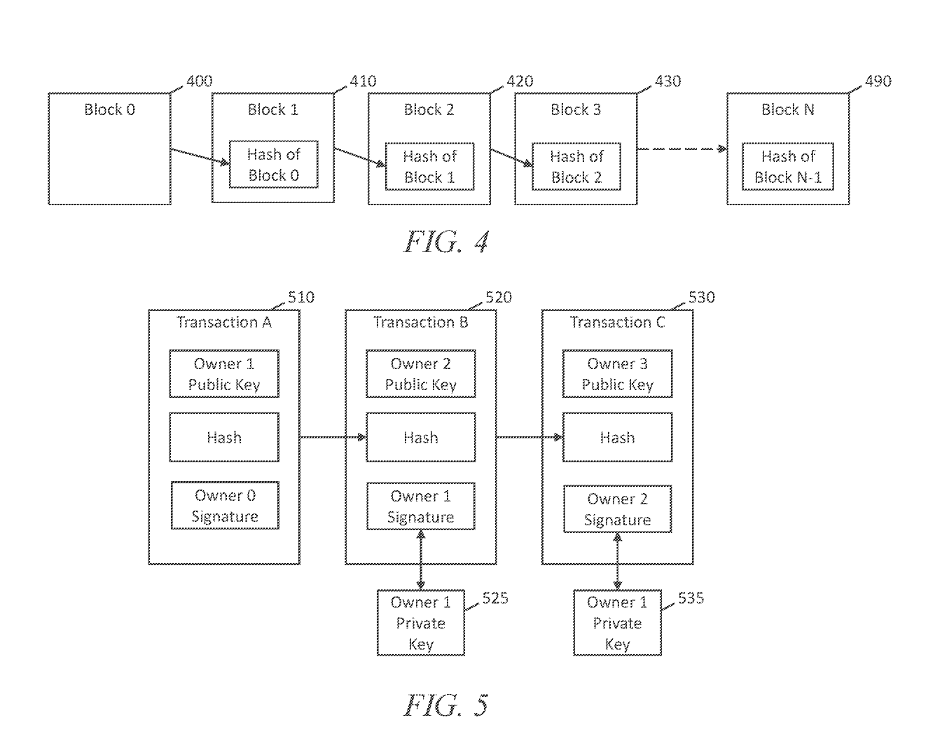

Descriptions of some embodiments of blockchain technology are provided with reference to FIGS. 4-9. One or more of the user interfaces (206 and 209) (and/or the apparatus (such as a so-called smartphone or desktop/laptop computer) that includes the user interface) described above may comprise a node in a distributed blockchain system storing a copy of the blockchain record. Updates to the blockchain may comprise printing instructions and/or printing authorizations and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

Generally speaking, a blockchain system can comprise a distributed timestamp server comprising a plurality of nodes configured to generate computational proof of record integrity and the chronological order of its use for content (such as printing instructions), trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash.

In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. (A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference).

Now referring to FIG. 4, an illustration of a blockchain according to some approaches is shown. By one approach, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N-1.

By one approach, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3.

If desired, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. By one approach, a block may generally contain any type of data and record. Each block may comprise a plurality of transaction and/or activity records.

By one approach, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action (such as a printing action) is authorized. For example, a block may contain a public key of an owner of an asset that allows the owner to show possession and/or transfer the asset using a private key.

Nodes may verify that the owner is in possession of the asset and/or is authorized to transfer the asset based on prior transaction records when a block containing the transaction is being formed and/or verified. By one approach, rules themselves may be stored in the blockchain such that the rules are also resistant to tampering once created and hashed into a block. By one approach, the blockchain system may further include incentive features for nodes that provide resources to form blocks for the chain. For example, in the Bitcoin system, “miners”are nodes that compete to provide proof-of-work to form a new block, and the first successful miner of a new block earns Bitcoin currency in return.

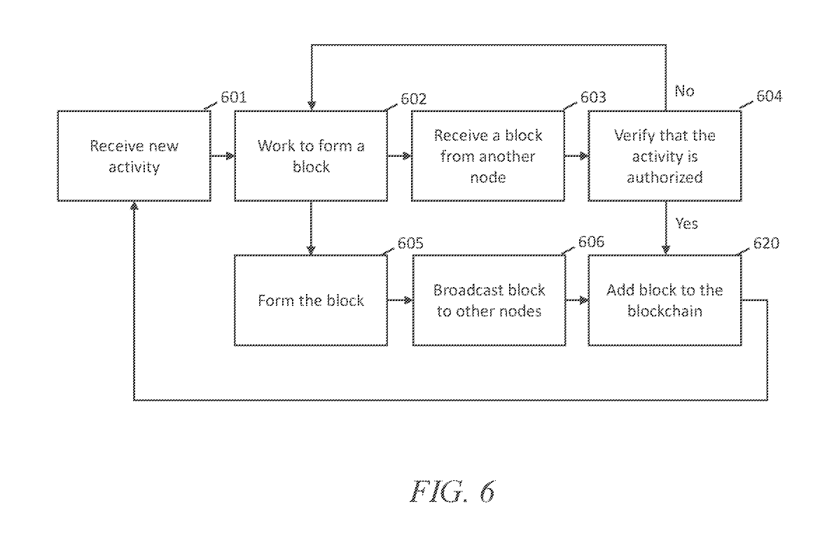

Now referring to FIG. 5, an illustration of blockchain based transactions according to some approaches is shown. By one approach, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed.

The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220.

By one approach, when each transaction record is created, the system may check previous transaction records and the current owner's private and public key signature to determine whether the transaction is valid. In some embodiments, transactions are broadcast in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending (or using) the asset.

The transactions in FIG. 5 are shown as an example only. By one approach, a blockchain record and/or the software algorithm may comprise any type of rules that regulate who and how the chain may be extended. By one approach, the rules in a blockchain may comprise clauses of a smart contract that is enforced by the peer-to-peer network.

Now referring to FIG. 6, a flow diagram is shown. By one approach, the steps shown in FIG. 6 may be performed by a processor-based device, such as a computer system, a server, a distributed server, a timestamp server, a blockchain node, and the like. By one approach, the steps in FIG. 6 may be performed by one or more of the nodes in a system using blockchain for record keeping.

In step 601, a node receives a new activity. The new activity may comprise an update to the record being kept in the form of a blockchain. By one approach, for blockchain supported digital or physical asset record keeping, the new activity may comprise an asset transaction. By one approach, the new activity may be broadcast to a plurality of nodes on the network prior to step 601.

In step 602, the node works to form a block to update the blockchain. By one approach, a block may comprise a plurality of activities or updates and a hash of one or more previous block in the blockchain. By one approach, the system may comprise consensus rules for individual transactions and/or blocks and the node may work to form a block that conforms to the consensus rules of the system. By one approach, the consensus rules may be specified in the software program running on the node. For example, a node may be required to provide a proof standard (e.g. proof of work, proof of stake, etc.) which requires the node to solve a difficult mathematical problem for form a nonce in order to form a block. By one approach, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. By one approach, in a system with incentive features, the first node to form a block may be permitted to add incentive payment to itself in the newly formed block. In step 620, the node then adds the block to its copy of the blockchain.

In the event that the node receives a block formed by another node in step 603 prior to being able to form the block, the node works to verify that the activity recorded in the received block is authorized in step 604. By one approach, the node may further check the new block against system consensus rules for blocks and activities to verify whether the block is properly formed. If the new block is not authorized, the node may reject the block update and return to step 602 to continue to work to form the block.

If the new block is verified by the node, the node may express its approval by adding the received block to its copy of the blockchain in step 620. After a block is added, the node then returns to step 601 to form the next block using the newly extended blockchain for the hash in the new block.

By one approach, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. By one approach, if a node goes offline for a time period, the node may retrieve the longest chain in the distributed system, verify each new block added since it has been offline, and update its local copy of the blockchain prior to proceeding to step 601.

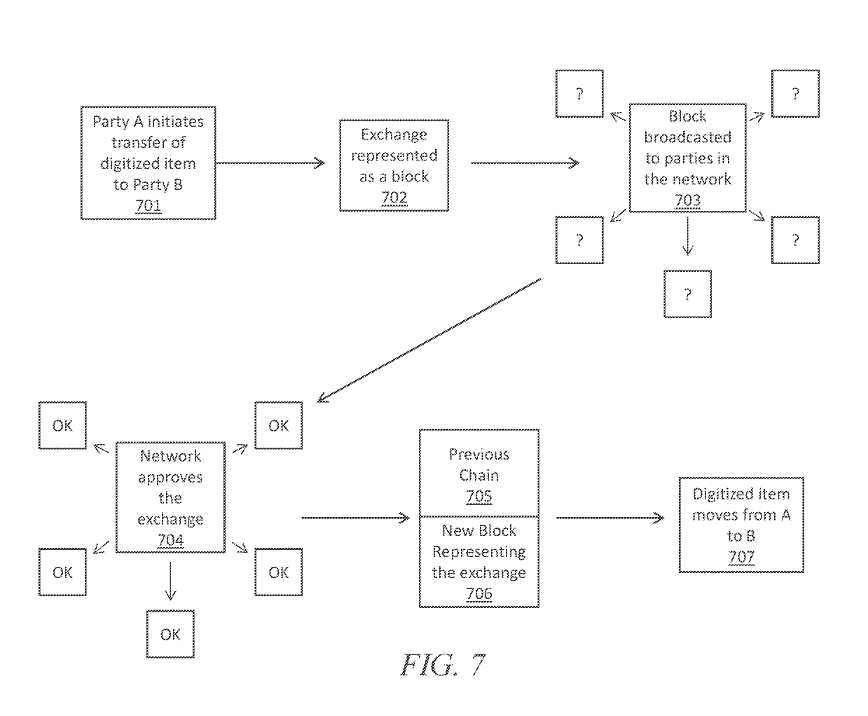

Now referring to FIG. 7, a process diagram illustrates a blockchain update according to some implementations. In step 701, party A initiates the transfer of a digitized item to party B. By one approach, the digitized item may comprise a digital currency, a digital asset, a document, rights to a physical asset, etc. By one approach, Party A may prove that he has possession of the digitized item by signing the transaction with a private key that may be verified with a public key in the previous transaction of the digitized item.

In step 702, the exchange initiated in step 701 is represented as a block. By one approach, the transaction may be compared with transaction records in the longest chain in the distributed system to verify part A's ownership. By one approach, a plurality of nodes in the network may compete to form the block containing the transaction record. By one approach, nodes may be required to satisfy proof-of-work by solving a difficult mathematical problem to form the block. By one approach, other methods of proof such as proof-of-stake, proof-of-space, and so forth may be used in the system. By one approach, the node that is first to form the block may earn a reward for the task as an incentive. For example, in the Bitcoin system, the first node to provide proof of work to for block the may earn a Bitcoin.

By one approach, a block may comprise one or more transactions between different parties that are broadcast to the nodes. In step 703, the block is broadcast to parties in the network. In step 704, nodes in the network approve the exchange by examining the block that contains the exchange. By one approach, the nodes may check the solution provided as proof-of-work to approve the block. By one approach, the nodes may check the transaction against the transaction record in the longest blockchain in the system to verify that the transaction is valid (e.g. party A is in possession of the asset he/she s seeks to transfer). By one approach, a block may be approved with consensus of the nodes in the network.

After a block is approved, the new block 706 representing the exchange is added to the existing chain 705 comprising blocks that chronologically precede the new block 706. The new block 706 may contain the transaction(s) and a hash of one or more blocks in the existing chain 705. By one approach, each node may then update their copy of the blockchain with the new block and continue to work on extending the chain with additional transactions. In step 707, when the chain is updated with the new block, the digitized item is moved from party A to party B.

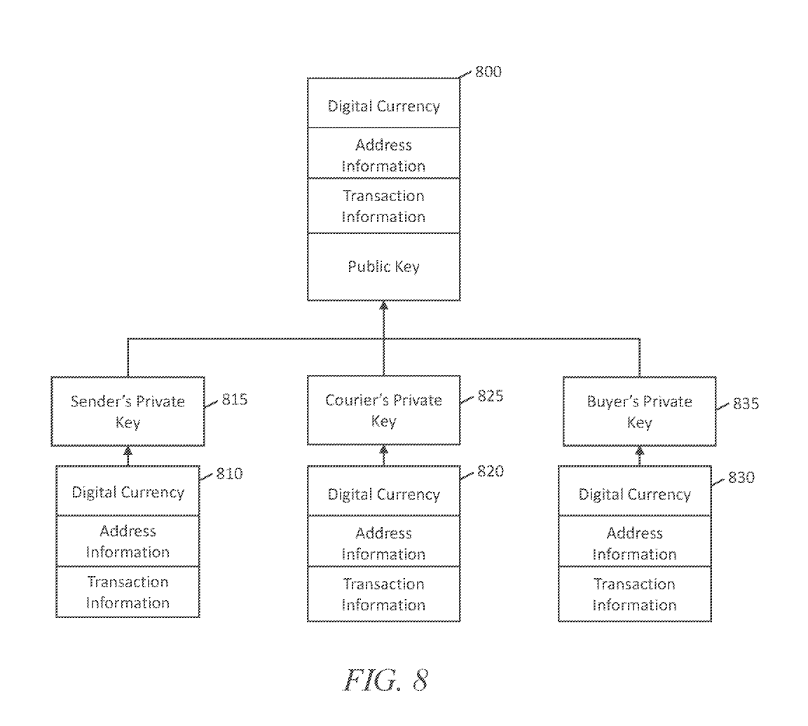

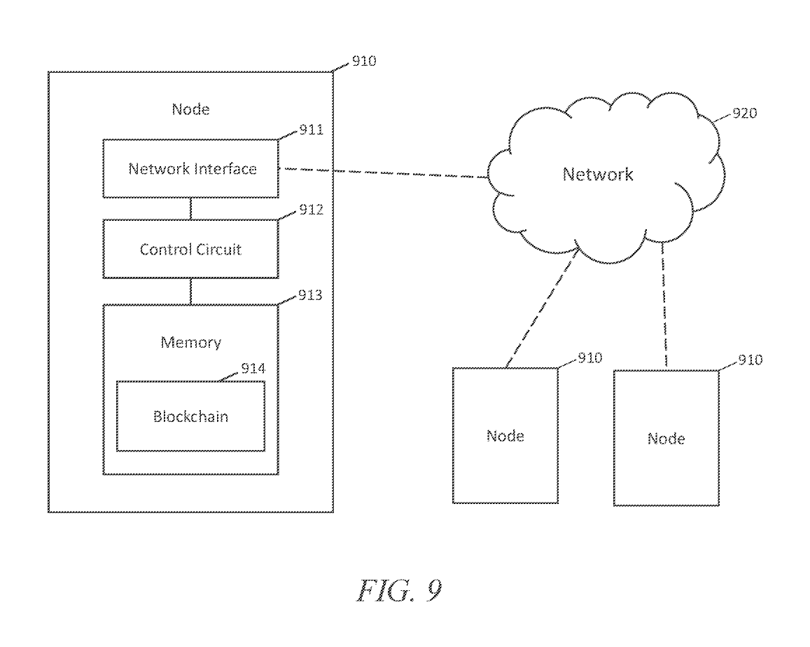

Now referring to FIG. 8, a diagram of an illustrative blockchain is shown. FIG. 8 comprises an example of an implementation of a blockchain system for delivery service record keeping. The delivery record 800 comprises digital currency information, address information, transaction information, and a public key associated with one or more of a sender, a courier, and a buyer.

By one approach, nodes associated the sender, the courier, and the buyer may each store a copy of the delivery record 810, 820, and 830 respectively. By one approach, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction.

By one approach, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction.

By one approach, the transfer from the courier to the buyer may require signatures from both the courier and the buyer using their respective private keys. The new transaction may be broadcast and verified by the sender, the courier, the buyer, and/or other nodes on the system before being added to the distributed delivery record blockchain.

With the approach shown in FIG. 8, the delivery record may be updated by one or more of the sender, courier, and the buyer to form a record of the transaction without a trusted third party while preventing unauthorized modifications to the record. By one approach, the blockchain based transactions may further function to include transfers of digital currency with the completion of the transfer of the physical asset. With the distributed database and peer-to-peer verification of a blockchain system, the sender, the courier, and the buyer can each have confidence in the authenticity and accuracy of the delivery record stored in the form of a blockchain.

Now referring to FIG. 9, an illustrative distributed blockchain system comprises a plurality of nodes 910 communicating over a network 920. By one approach, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. By one approach, the control circuit 912 may further be configured to extend the blockchain 914 by processing updates to form new blocks for the blockchain 914. Generally, each node may store a version of the blockchain 914, and together, may form a distributed database. By one approach, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. By one approach, the network 920 may comprise one or more of the Internet, a local area network, a private network, a virtual private network, a home network, a wired network, a wireless network, and the like. By one approach, the system does not include a central server and/or a trusted third party system. Each node in the system may enter and leave the network at any time.

With the system and processes shown in, once a block is formed, the block cannot be changed without redoing the work to satisfy consensus rules thereby securing the block from tampering. An attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

By one approach, a blockchain may be used to secure digital documents such as printing instructions, digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud.

By one approach, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

By one approach, in the peer-to-peer network, the longest chain proves the sequence of events witnessed, proves that it came from the largest pool of processing power and that the integrity of the document has been maintained. By one approach, the network for supporting blockchain based record keeping requires minimal structure. By one approach, messages for updating the record are broadcast on a best-effort basis. Nodes can leave and rejoin the network at will and may be configured to accept the longest proof-of-work chain as proof of what happened while they were away.

By one approach, a blockchain based system allows content use, content exchange, and the use of content for remuneration based on cryptographic proof instead of trust, allowing any two willing parties to employ the content without the need to trust each other and without the need for a trusted third party. By one approach, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

So configured, the teachings provided herein employ technology to greatly increase the likelihood that printing a particular-dimensional object for a third party entity (which third party entity may be essentially unknown and untouched) will not constitute an infringement of another party's intellectual property rights. These teachings are highly amenable to automation and hence can typically achieve this desirable result with little if any human oversight and likely little or no perceptible delay with respect to the overall process.

Those skilled in the art will recognize that a wide variety of modifications, alterations, and combinations can be made with respect to the above-described embodiments without departing from the scope of the invention and that such modifications, alterations, and combinations are to be viewed as being within the ambit of the inventive concept. As one illustrative example, by one approach a collection of public domain three-dimensional objects can be maintained to thereby permit this process to identify and positively confirm that printing instructions as proffered by a particular entity correspond to a public domain object that can be printed with legal impunity.

What is claimed is:

1. An apparatus to facilitate controlling use of printing instructions for a particular three-dimensional object by an additive-material printer, the apparatus comprising:
an additive-material printer;
a control circuit operably coupled to the additive-material printer and configured to:
access the printing instructions as provided by a user;
assess the printing instructions to determine inclusion of printing authorization from a presumptive source of the printing instructions;
upon determining that the printing instructions lack the printing authorization, halt the use of the printing instructions;
upon determining that the printing instructions include the printing authorization, further assess the printing instructions to thereby further test legal suitability of using the printing instructions with the additive-material printer to form the particular three-dimensional object;
upon establishing the further legal suitability of using the printing instructions, using the additive-material printer to form the particular three-dimensional object.

2. The apparatus of claim 1 wherein the control circuit is configured to access the printing instructions as provided by a user by accessing the printing instructions as provided by a user in a blockchain block.

3. The apparatus of claim 1 wherein the printing authorization includes a blockchain public key corresponding to the presumptive source.

4. The apparatus of claim 1 wherein the control circuit is further configured to:
assess the printing authorization to determine a number of authorized copies that are permitted by the printing authorization.

5. The apparatus of claim 1 wherein the control circuit is configured to test the legal suitability of using the printing instructions with the additive-material printer to form the particular three-dimensional object by, at least in part, comparing information regarding the particular three-dimensional object to stored information regarding a plurality of protected objects.

6. The apparatus of claim 5 wherein the control circuit is configured to compare the information by forwarding at least part of the printing instructions to a remote resource that conducts the comparison.

7. The apparatus of claim 1 wherein the control circuit is further configured to:
upon determining that it is not legally suitable to use the printing instructions with the additive-material printer to form the particular three-dimensional object, halt the use of the printing instructions.

8. The apparatus of claim 1 wherein the control circuit is further configured to:
upon determining that it is not legally suitable to use the printing instructions with the additive-material printer to form the particular three-dimensional object, automatically provide corresponding information to a legally-relevant entity.

9. The apparatus of claim 8 wherein the legally-relevant entity is a presumptive source of the particular three-dimensional object.

10. The apparatus of claim 8 wherein the control circuit is further configured to:
upon determining that it is not legally suitable to use the printing instructions with the additive-material printer to form the particular three-dimensional object, also halt the use of the printing instructions.

11. A method to facilitate controlling use of printing instructions for a particular three-dimensional object by an additive-material printer, the method comprising:
by a control circuit:
accessing the printing instructions as provided by a user;
assessing the printing instructions to determine inclusion of printing authorization from a presumptive source of the printing instructions;
upon determining that the printing instructions lack the printing authorization, halting the use of the printing instructions;
upon determining that the printing instructions include the printing authorization, further assessing the printing instructions to thereby further test legal suitability of using the printing instructions with the additive-material printer to form the particular three-dimensional object;
upon establishing the further legal suitability of using the printing instructions, using the additive-material printer to form the particular three-dimensional object.

12. The method of claim 11 wherein accessing the printing instructions as provided by a user comprises accessing the printing instructions as provided by a user in a blockchain block.

13. The method of claim 11 wherein the printing authorization includes a blockchain public key corresponding to the presumptive source.

14. The method of claim 11 further comprising:
assessing the printing authorization to determine a number of authorized copies that are permitted by the printing authorization.

15. The method of claim 11 wherein testing the legal suitability of using the printing instructions with the additive-material printer to form the particular three-dimensional object comprises, at least in part, comparing information regarding the particular three-dimensional object to stored information regarding a plurality of protected objects.

16. The method of claim 15 wherein comparing the information comprises forwarding at least part of the printing instructions to a remote resource that conducts the comparison.

17. The method of claim 11 further comprising:
upon determining that it is not legally suitable to use the printing instructions with the additive-material printer to form the particular three-dimensional object, halting the use of the printing instructions.

18. The method of claim 11 further comprising:
upon determining that it is not legally suitable to use the printing instructions with the additive-material printer to form the particular three-dimensional object, automatically providing corresponding information to a legally-relevant entity.

19. The method of claim 18 wherein the legally-relevant entity is a presumptive source of the particular three-dimensional object.

20. The method of claim 18 further comprising:
upon determining that it is not legally suitable to use the printing instructions with the additive-material printer to form the particular three-dimensional object, also halting the use of the printing instructions.
